(19) United States
(12) Patent Application Publication
(10) Pub. No.: US 2015/0080122 A1
(43) Pub. Date: Mar. 19, 2015

(54) NON-TRANSITORY COMPUTER-READABLE STORAGE MEDIUM, GAME APPARATUS, GAME SYSTEM AND GAME PROCESSING METHOD

(71) Applicant: NINTENDO CO., LTD., Kyoto (JP)

(72) Inventors: Kenta MOTOKURA, Kyoto (JP); Katsuyasu ANDO, Kyoto (JP)

(73) Assignee: NINTENDO CO., LTD., Kyoto (JP)

(21) Appl. No.: 14/089,796

(22) Filed: Nov. 26, 2013

(30) Foreign Application Priority Data
Sep. 13, 2013 (JP) 2013-190514

(51) Int. Cl. A63F 13/00

(52) U.S. Cl. CPC A63F 13/00
USPC 463/31

(57) ABSTRACT

There is provided a game apparatus capable of providing enhanced player controllability of characters in a game where a plurality of characters are controlled in a virtual space. An example game apparatus 10 that executes a game where a plurality of characters in a virtual space are controlled includes an input unit 11 for receiving a command from a player and an information processing unit 14 moving a plurality of characters according to the command from the player and on the basis of a relative positional relation between the plurality of characters in the virtual space. When the plurality of characters are not in a predetermined relative positional relation, the plurality of characters are moved according to the command from the player so as to bring the plurality of characters into a fixed positional relation.

### CROSS REFERENCE TO RELATED APPLICATION

The disclosure of Japanese Patent Application Laid-Open No. 2013-190514 filed on Sep. 13, 2013 is incorporated herein by reference in its entirety.

### FIELD

The technology herein relates to a non-transitory computer-readable storage medium, game apparatus, game system, and game processing method and, in particular, to a non-transitory computer-readable storage medium, game apparatus, game system and game processing method of executing a game where characters are controlled in a virtual space.

### BACKGROUND AND SUMMARY

Games in which a player controls a character in a virtual space in attempt to achieve a predetermined objective (for example, to earn points while averting attacks by opponents or attacking opponents in attempt to reach a goal) are known. Some of such games include a multiplayer mode in which multiple players control their respective characters in a virtual space to compete with each other in order to achieve a goal first or control their respective characters to cooperate with each other to achieve an objective.

A feature is also known that adds a character controlled in a virtual space in the game when a character satisfies a predetermined condition (for example when a character acquires a predetermined item).

The present disclosure provides a game system capable of providing enhanced player controllability of characters in a game where a plurality of characters are controlled in a virtual space.

A non-transitory computer-readable storage medium of an example embodiment stores a game program to be executed by a computer of a game apparatus. The game apparatus includes an input unit for receiving a command from a player, and executes a game in which a plurality of characters in virtual reality are controlled. Specifically, the game program causes the computer to function as an information processing unit moving a plurality of characters according to the command and a relative positional relation between the plurality of characters in the virtual space. This configuration can provide enhanced controllability because a plurality of characters in a game where the plurality of characters are controlled in a virtual space are moved according to a command from a player and are also moved on the basis of a relative positional relation between the plurality of characters.

The plurality of characters may be individually subjected to a restriction on movement and the relative positional relation between the plurality of characters may change accordingly. The configuration is capable of making the players as if the player were simultaneously directing the individual characters to act rather than directing the characters to act as an enlarged mass, because the relative positional relation between the plurality of characters is not fixed.

When the plurality of characters are not in a predetermined relative positional relation, the information processing unit may move the plurality of characters according to the command to bring the plurality of characters into the predetermined relative positional relation. According to this configuration, when the relative positional relation between a plurality of characters has changed, the plurality of characters are restored to a predetermined relative positional relation (fixed positional relation). Therefore, the plurality of characters can be prevented from dispersing indefinitely in the virtual space, thereby providing enhanced controllability when controlling actions of the plurality of characters.

When the plurality of characters are not in a predetermined relative positional relation, the information processing unit may move the plurality of characters according to the command by making the rate of movement of at least one of the plurality of characters different from the rate of movement of the other characters to bring the plurality of characters into the predetermined relative positional relation. According to this configuration, since the rate of movement is adjusted to restore a predetermined relative positional relation between the plurality of characters during movement according to a command from the player in response to the command, the plurality of characters can be restored to the predetermined relative positional relation (fixed positional relation) without making the player who has issued the move command feel that the restoration is unnatural.

When the plurality of characters are not in a predetermined relative positional relation, the information processing unit may move the plurality of characters according to the command to gradually bring the plurality of characters into the predetermined relative positional relation. Since the plurality of characters are gradually restored to a predetermined relative positional relation (fixed positional relation), the predetermined relative positional relation (fixed positional relation) between the plurality of characters can be restored without making the player who has issued the move command feel that the restoration is unnatural.

The predetermined relative positional relation may be a positional relation in which the plurality of characters are arranged side by side. This configuration is capable of making the player as if the player were directing the entire group of the plurality of characters to move according to a command.

The information processing unit may change the direction in which the plurality of characters are arranged according to the command. This configuration also is capable of making the player feel as if the player were directing the entire group of characters to move according to a command.

The predetermined relative positional relation may be a positional relation in which the plurality of characters are arranged in the direction perpendicular to a direction of movement specified by the command. This configuration is capable of making the player feel as if the player were directing the entire group of the plurality of characters to move without making the player feel that one of the characters is a leader and the other are follower.

The information processing unit may add a character in the virtual space to produce the plurality of characters. This configuration allows the number of characters to be increased rather than being fixed.

When any of the plurality of characters satisfies a predetermined condition for adding a character, the information processing unit may produce a clone character from the character to add the character. This configuration is capable of making the player feel as if the player were directing the entire group of characters to act.

The information processing unit may add the character on conditions that the addition does not cause a predetermined upper limit of the number of the characters to be exceeded. This configuration is capable of preventing the number of characters from increasing infinitely.

The plurality of characters may have the same appearance. This configuration is capable of making the player feel as if the player is directing the entire group of characters to act according to a command.

All of the plurality of characters may have the same abilities. This configuration can avoid degradation of controllability due to varying abilities of characters when the player directs the entire group of characters to act according to a command.

A game apparatus of an example embodiment is a game apparatus that executes a game in which a plurality of characters in a virtual space are controlled. The game apparatus includes an input unit for receiving a command from a player and an information processing unit moving the plurality of characters according to the command as well as a relative positional relation between the plurality of characters in the virtual space. This configuration is capable of providing enhanced controllability because a plurality of characters in a game where a plurality of characters are controlled in a virtual space are moved according to a command from the player as well as on the basis of a relative positional relation between the plurality of characters.

A game system of an example embodiment is a game system that executes a game in which a plurality of characters in a virtual space are controlled. The game system includes an input unit for receiving a command from a player and an information processing unit moving the plurality of characters according to the command and a relative positional relation between the plurality of characters in the virtual space. This configuration is capable of providing enhanced controllability because a plurality of characters in a game where a plurality of characters are controlled in a virtual space are moved according to a command from the player as well as on the basis of a relative positional relation between the plurality of characters.

A game processing method of an example embodiment is a game processing method of executing a game in which a plurality of characters are controlled in a virtual space. The game processing method includes a command receiving step of receiving a command from a player and an information processing step of moving the plurality of characters according to the command as well as a relative positional relation between the plurality of players in the virtual space. This configuration is capable of providing enhanced controllability because a plurality of characters in a game where a plurality of characters are controlled in a virtual space are moved according to a command from the player as well as on the basis of a relative positional relation between the plurality of characters.

The technology described in the present application is capable of providing enhanced player controllability of characters in a game where players control a plurality of characters in a virtual space.

### BRIEF DESCRIPTION OF THE DRAWINGS

FIG. 1 shows a configuration of an example non-limiting apparatus;

FIG. 2 shows an example non-limiting screen in which a clone character appears and an example non-limiting operation on a controller;

FIG. 3 shows an example non-limiting screen in which an action-ability of a character is raised and an example non-limiting operation on a controller;

FIG. 4 shows an example non-limiting screen in which a character is damaged and an example non-limiting operation on a controller;

FIG. 5 shows an example non-limiting screen showing a basic positional relation between a plurality of characters and an example non-limiting operation of controller;

FIG. 6 shows an example non-limiting screen in which an obstacle restricts movement of one or more of characters and an example non-limiting operation on a controller;

FIG. 7 shows an example non-limiting screen in which a plurality of characters that have moved away from each other are restored to a predetermined relative positional relation and an example non-limiting operation on a controller;

FIG. 8 is a flowchart showing an example non-limiting process for restoring a plurality of characters to a predetermined relative positional relation; and

FIG. 9 shows an example non-limiting screen in which a player captures a character of another player and an example non-limiting operation on a controller.

### DETAILED DESCRIPTION OF NON-LIMITING EXAMPLE EMBODIMENTS

Non-limiting example embodiments of the present technology will be described with reference to the accompanying drawings. The non-limiting example embodiments described below are only illustrative of implementation of the present technology and are not intended to limit the present technology to the specific configurations described below. Any specific configurations may be employed to implement the present technology according to embodiments.

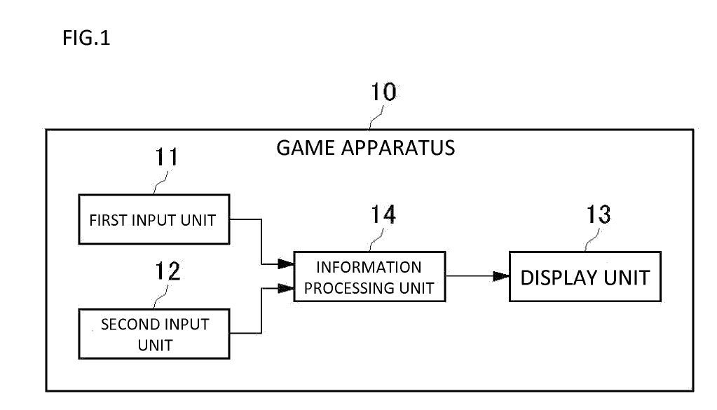

FIG. 1 shows a configuration of an example non-limiting game apparatus. The game apparatus 10 includes a first input unit 11, a second input unit 12, a display unit 13 and an information processing unit 14. The second input unit 12 is used in a multiplayer mode, which will be described later. When the game apparatus 10 does not have a multiplayer mode, the second input unit 12 is optional. For example, a portable game apparatus that incorporates the first input unit 11, the display unit 13 and the information processing unit 14 in one and has only a singleplayer mode may be configured.

Alternatively, the first input unit 11 and the second input unit 12 of the game apparatus 10 may be separate controllers. The information processing unit 14 may be a game machine main unit that receives operation signals via cable or wirelessly from the controllers, which are the first input unit 11 and the second input unit 12. The display unit 13 may be an interface that sends video signals to a monitor on the game machine main unit.

Alternatively, the game apparatus 10 may be configured as a game system including a game server on a network and a game terminal capable of communicating with the network game server. In that case, the game server provided with the functions of the information processing unit 14 and the game terminal is equipped with the first input unit 11, the second input unit 12 and the display unit 13. A game terminal equipped with the first input unit 11 and the display unit 13 and a separate game terminal equipped with the second input unit 12 and the display unit 13 may be provided. In the game system, operations on the first input unit 11 and the second input unit 12 by users are sent to the game server as operation signals over the network and video signals sent from the game server over the network are displayed on the display units 13 of the game terminals.

The information processing unit 14 is a computer including a processor, a memory, a storage, and other components. The computer executes a game program of the example non-limiting embodiment to implement the information processing unit 14 of the example non-limiting embodiment. The information processing unit 14 may be configured as a single apparatus or partial functions of the information processing unit 14 may be distributed among a plurality of apparatuses. The game program may be provided via a storage medium such as a cartridge to the game machine, or may be preinstalled in the game machine at the time of manufacture of the game machine, or may be downloaded by the game machine over the network to the game machine.

The first input unit 11 and the second input unit 12 may be controllers including a directional control for specifying a direction and a plurality of buttons for issuing commands for executing various actions, which will be described later. The directional control may be a cross-keypad for specifying up, down, left and right directions or may be a 360-degree stick for steplessly specifying directions. Each of the first input unit 11 and the second input unit 12 functioning as controllers may include an acceleration sensor to detect acceleration produced by a player moving the controller, thereby accepting a command that specifies a direction. Each of the first input unit 11 and the second input unit 12 may include an image pickup unit that captures an image of an action of the player to accept a command from the player.

While the present non-limiting example embodiment will be described by taking an example where the game apparatus 10 includes two input units and has a multiplayer mode in which two players play, the game apparatus 10 may have a multiplayer mode in which three or more players can play. In that case, the game apparatus 10 includes as many input units as the number of the players.

An overview of a game executed on the game apparatus 10 will be described first. The game has a singleplayer mode in which a single player plays and a multiplayer mode in which a plurality of players play at the same time. Details common to the singleplayer mode and the multiplayer mode will be described by taking the singleplayer mode as an example for simplicity.

The objective of the game is for a player (user) to control a character in a virtual space to move the character in the virtual space to reach a goal. The player can control the character to perform actions. The actions performed by the character include movement and various actions. Examples of movement include walking (on land), running, climbing (a wall and the like), and swimming (surface and underwater). Examples of actions include jumping and other actions. The character can also fly (in the air) and can use attack items according to moving abilities and action abilities.

Constructions, opponents, obstacles and various kinds of items are provided in the virtual space. The player controls the character to move toward the goal in the virtual space while averting or protecting against attacks from opponents and obstacles, attacking opponents and obstacles, and earning points by acquiring items. Details of the game will be described below.

### [Clones]

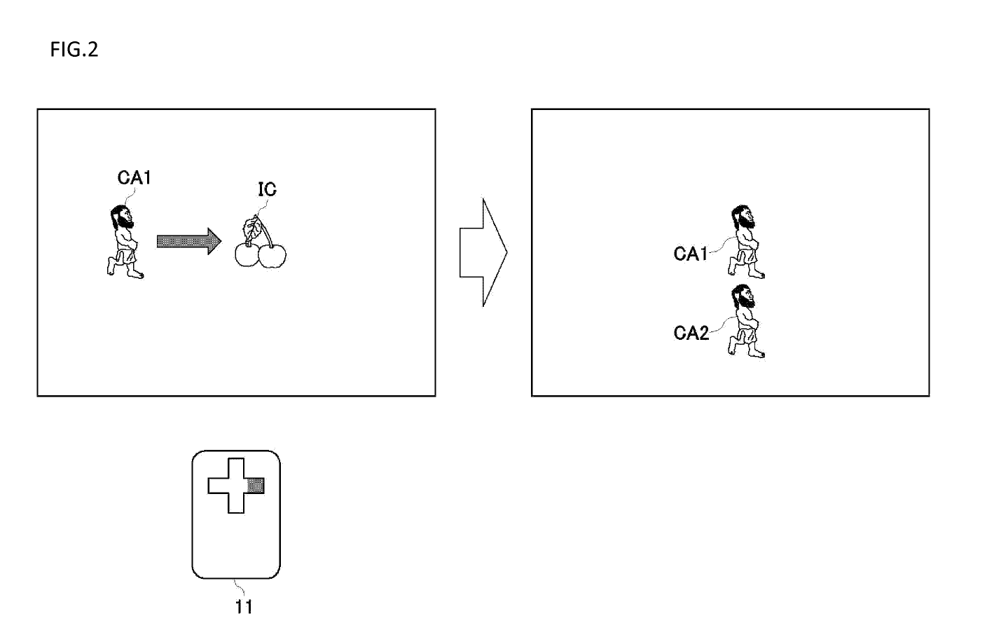

When a predetermined condition for addition is satisfied, such as when the character acquires a predetermined cloning item, a clone of the character is added in the virtual space. Specifically, the character can produce a clone of the character. Hereinafter, one or more of a plurality of characters produced as clones will be sometimes referred to as “clone character(s)”. FIG. 2 shows an example non-limiting screen where a clone character is produced and an operation on a controller for producing a clone character. When a character CA1 acquires a cherry item IC, which is a cloning item, a clone character CA2 is produced. As illustrated in FIG. 2, the clone character CA2 is a replica of the original character CA1 that has produced the clone character CA2 and has the same appearance as the original character CA1.

In order to allow the character CA1 to acquire the cherry item IC, the player operates the controller 11 to move the character CA1 to the location of the cherry item IC. Since the cherry item IC is located to the right of the character CA1 in the example in FIG. 2, the player operate the right button on the controller 11 to move the character CA1 rightward to allow the character CA1 to acquire the cherry item IC.

When any of clone characters produced satisfies a predetermine condition for producing a clone, an additional clone character is produced. In this way, the player can repeatedly produce a clone character to increase the number of characters. However, an upper limit of the number of clone characters is preset and once the upper limit is reached, no additional clone character is produced even when the predetermined condition for producing a clone is satisfied.

Once a clone character is produced so that there are multiple characters, the characters are not in a leader-follower relationship. The player can control the plurality of characters by issuing a single command. Specifically, when the player issues, for example, a command to move the character in a particular direction, all of the characters including the clone character(s) move together in that direction in the virtual space; when the player issues a command to cause the character to jump, all of the characters including the clone character(s) jump together in the virtual space; when the player issues a command to cause the character to attack, all of the characters in including the clone character(s) attack together.

The plurality of characters including the clone character(s) are not in a leader-follower relationship but are on an equality with each other. When a character satisfies a predetermined extinction condition, the character that satisfies the extinction condition dies and disappears from the virtual space as will be described later. However, since the plurality of characters are not in a leader-follower relationship but are on an equality with each other as stated above, the player can continue the game as long as at least one character is surviving even when any of the other characters die.

### [Improvement of Abilities]

When a character in the virtual space satisfies a predetermined ability improvement condition, for example when a character acquires an ability improving item, the moving ability or action ability of the character (hereinafter collectively and simply referred to as “ability”) can be improved. If there are a plurality of characters due to cloning and any of the characters satisfies the predetermined condition, the ability of all of the characters is improved.

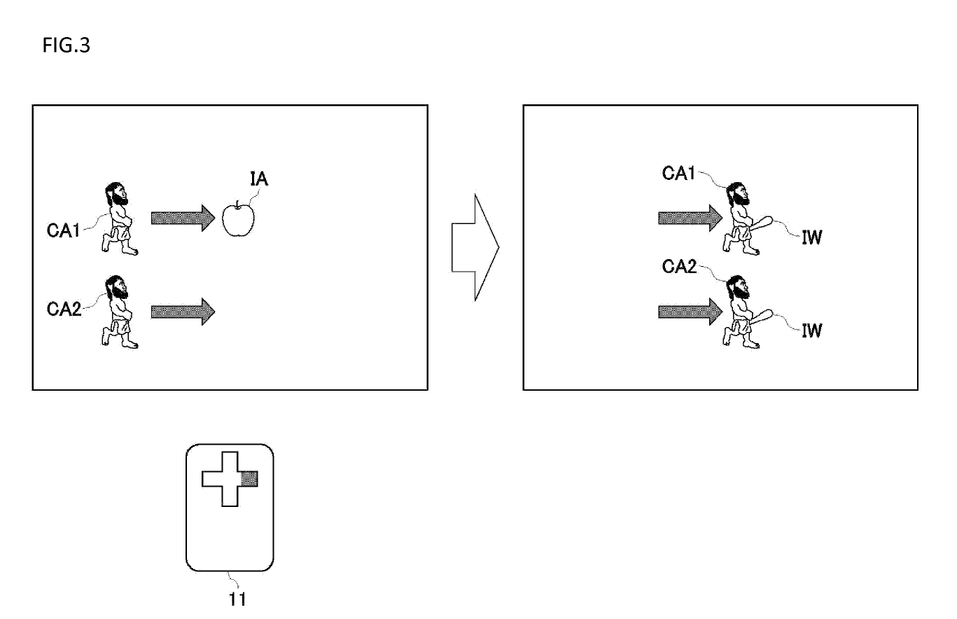

FIG. 3 shows an example non-limiting screen where the action ability of characters is improved and an operation on a controller. In the example in FIG. 3, there are two characters CA1 and CA2 because of cloning. When the character CA1 acquires an apple item IA, which is an ability improving item, the ability of the character CA1 that has acquired the apple item IA as well as the ability of the character CA2 is improved. In the example in FIG. 3, attack ability, which is an action ability, is improved.

As the ability is improved, the appearance of the characters CA1 and CA2 changes accordingly. In the example in FIG. 3, the appearance of the characters changes, so that the characters hold a weapon item IW. The improvement of the attack ability allows characters CA1 and CA2 to attack with the weapon item IW.

Examples of improvement of moving ability include speeding up of movement and gaining new ability such as the ability to fly in the air. Since the ability of a plurality of characters is improved at the same time as has described above, conditions are avoided where one or more of the plurality of characters are able to run faster than the others or one or more of the plurality of characters are able to fly in the air so that the plurality of characters readily move away from one another and controllability is degraded.

### [Damages]

When a predetermined damage condition is satisfied, such as when a character is attacked, the character is damaged. When a character that has no clone is damaged, the ability of the character is reduced if the ability of the character has been improved; if the ability of the character is at the lowest level (a usual condition) the character dies and disappears. If there are a plurality of characters due to cloning and any of the characters is damaged, only the damaged character dies and the other character(s) survives. In this case, even if the ability of the plurality of characters has been improved, the damaged character dies rather than the ability of the character being reduced.

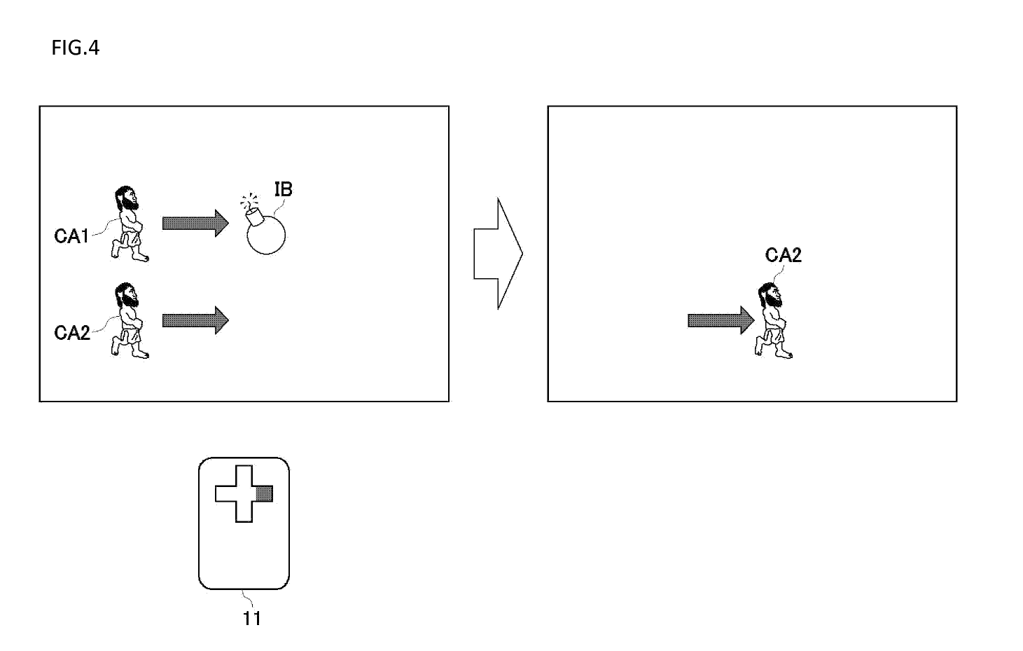

FIG. 4 shows an example non-limiting screen where a character is damaged and an operation on a controller. In the example in FIG. 4, there are two characters CA1 and CA2 due to cloning. When the character CA1 comes in contact with a bomb item IB, which is an attack item, the character CA1 dies and disappears. Here, the character CA2, which has not come into contact with the bomb item IB continues to live.

A character can be damaged when the character comes into contact with an attack item as illustrated in FIG. 4 or when the character is attacked by an opponent character, or when the character moves into a certain damage area in the virtual space.

### [Relative Positional Relation Between Characters]

As has been described above, in the game of the present non-limiting embodiment, when a character satisfies a predetermined condition, a clone of the character is produced and the player can control the plurality of characters by issuing a single command. However, if a plurality of characters move excessively far away from one another in the game of the present example non-limiting embodiment in which characters move forward in the virtual space, it will be difficult to control the characters. To avoid this, in a situation where there are a plurality of characters due to cloning in the game of the present example embodiment, the following process is performed for the relative positional relation between a plurality of characters in order to improve the character controllability when a player controls a plurality of characters with a single command.

### (Fixed Positional Relation)

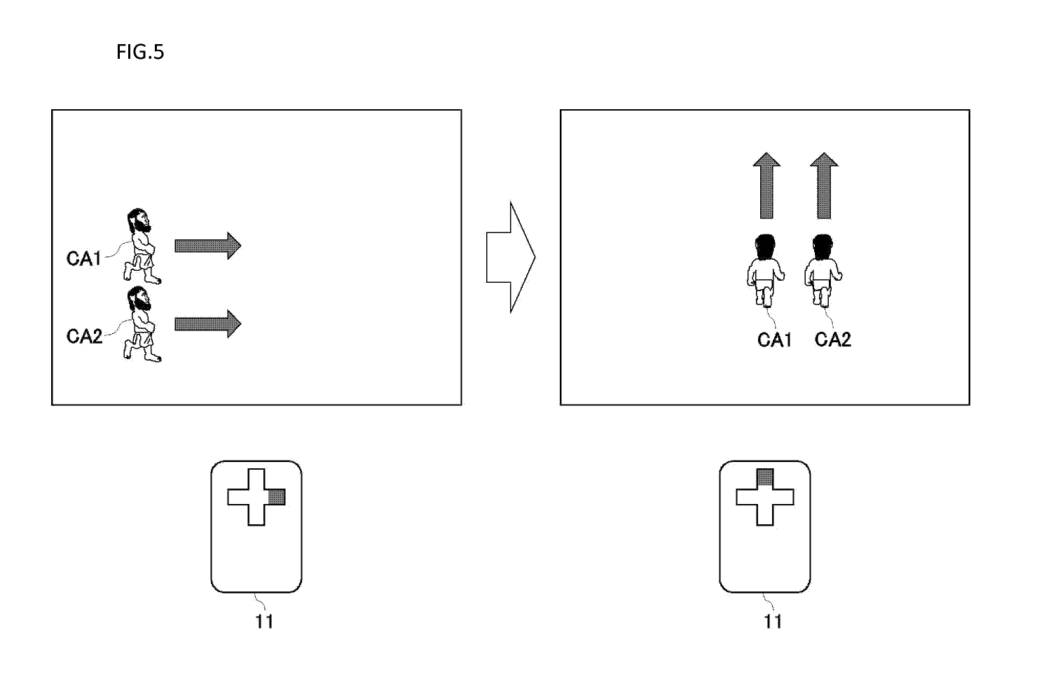

When there are a plurality of characters, the basic relative positional relation between the plurality of characters (hereinafter referred to the “fixed positional relation”) is such that the characters are located closely side by side. FIG. 5 shows an example non-limiting screen showing the basic positional relation between a plurality of characters and an operation on a controller. When there are a plurality of characters as shown in FIG. 5, the characters are in the basic positional relation in which the characters are located side by side.

When a player use a direction control key on the controller 11 to move characters leftward or rightward as shown in FIG. 5, the plurality of characters arrange themselves vertically. When the player operates the direction control key on the controller 11 to move the characters upward or downward, the plurality of characters arrange themselves horizontally. While two characters are shown in FIG. 5, the same applies to a situation where there are three or more characters. That is, when there are a plurality of characters, the characters arrange themselves in the direction perpendicular to the direction of movement. Similarly when a plurality of characters are moved in an oblique direction, the characters arrange themselves in the direction perpendicular to the direction of movement.

Since characters are arranged in the direction perpendicular to the direction of movement in this way, the player feels as if the player is controlling the plurality of characters at the same time with one command rather than feeling that any of the character is the leader and the other(s) is a follower. That is, if a plurality of characters were arranged horizontally when the characters are moving in a horizontal direction, the player would feel that the character in the front in the direction of movement is the leader and the character(s) in the rear in the direction of movement is the character(s) following the character in the front and feel as if the player was controlling only the character in the front. The present example non-limiting embodiment, on the other hand, does not make the player feel that way but makes the player feel as if the player is controlling all of the characters.

When the movement changes from horizontal to vertical as shown in FIG. 5, the plurality of characters gradually changes the relative positional relation between the characters from vertical to horizontal. Thus, the direction of movement of the plurality of characters can be changed without making the player feel that the relative positional relation is unnaturally changing.

If there are many characters, the characters do not necessarily need to be arranged in a line in the direction perpendicular to the direction of movement. For example, if there are three characters, two of the characters may be arranged in the front in a line in the direction perpendicular to the direction of movement and the remaining one character is placed behind them so that the characters are arranged in inverted triangle. If there are four characters, the characters may be arranged in a square formation. These formations do not impair user's feeling of controlling all of the characters. If characters are arranged in a line or in a triangular or square formation, a certain distance may be maintained between two adjacent characters.

### (Restricting Movement)

Blocking areas where characters cannot enter (for example rivers) and obstacle items (for example trees and constructions such as fences) that impede the movement of characters are provided in the virtual space. Those areas and obstacle items prevent characters from moving regardless of a command from the player. If there are a plurality of characters due to cloning and some of the characters are prevented from moving, the plurality of characters cannot maintain the fixed positional relation and the distances between characters will increase.

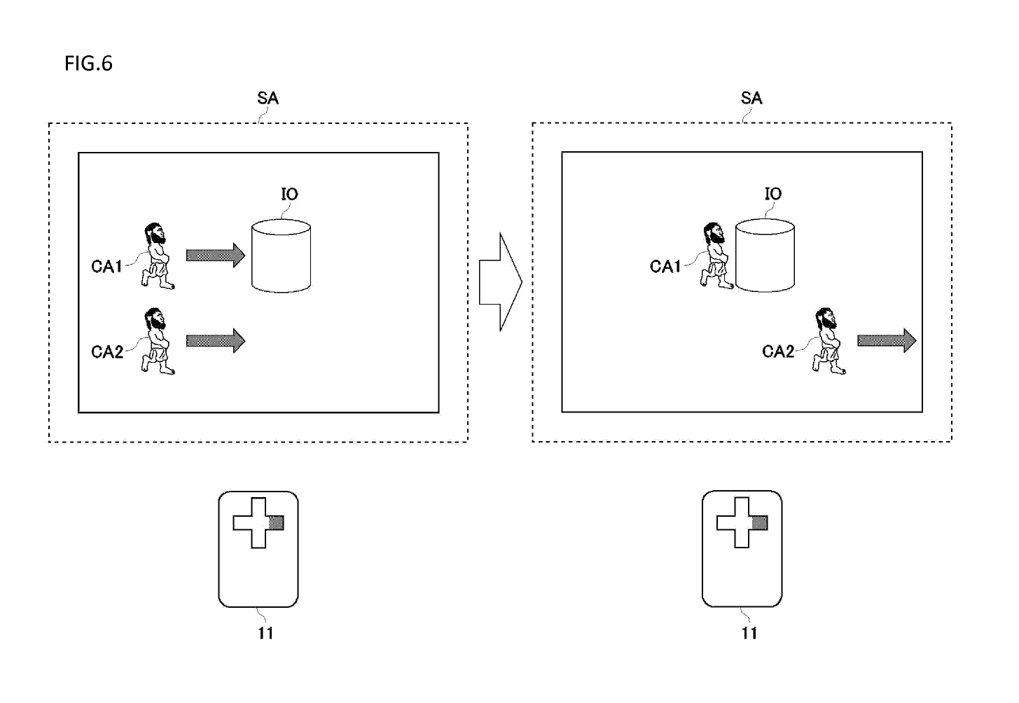

FIG. 6 shows an example non-limiting screen where movement of a character is restricted by an obstacle and an operation on a controller. If there are two characters CA1 and CA2 and there is an obstacle item IO in the direction of movement of the character CA1 (on the right side) as shown in FIG. 6, when the player issues a command to move rightward, the character CA2 moves rightward according to the command from the player whereas the character CA1 is prevented from moving rightward by the obstacle item IO.

As a result, the fixed positional relation between the characters CA1 and CA2 arranged vertically changes so that only the character CA2 moves rightward according to the command whereas the character CA1 is prevented from moving by the obstacle item IO and remains there. Consequently, the distance between the characters CA1 and CA2 increases.

When the distance between characters increases and exceeds the size of the screen, an image of the virtual space is displayed so as to display the character in the front of the movement. As a result, the character that is prevented from moving goes out of the screen.

A survival area SA is provided outside the screen that has a constant width. A character that goes out of the screen can survive in the survival area SA but, when the distance between the characters increases and the character outside the screen goes out of the survival area SA, the character dies and disappears. Note that when a character is outside the screen, control by the player is effective on the character as long as the character is within the survival area.

When the player continues issuing the command to move rightward in the example in FIG. 6, the image of the screen scrolls with the movement of the character CA2 and the character CA1, which is prevented from moving rightward, eventually goes out of the left screen bound. As the player further continues issuing the command to move rightward, the character CA1 goes out of the survival area SA, dies and disappears. Even when the character CA1 goes out of the screen, control by the player is effective on the character CA1 as well as long as the character CA1 is in the survival area SA. For example, when the character CA1 moves downward together with the character CA2 according to a command to move downward and moves off the obstacle item IO, the character CA1 becomes able to move rightward.

When movement of any of the characters is prevented and the distance between the characters becomes so far that the character goes out of the screen while the character in the front of the movement remains displayed in the screen, the following exceptional handling is performed if the character displayed in the screen moves back toward the character that is prevented from moving. In this case, although the character prevented from moving is in the front in the direction of movement, the virtual space portion including the character that was in the front in the previous direction of movement is displayed, instead of immediately displaying the virtual space portion including the character that was prevented from movement and now in the front in the movement in response to the change of the direction of movement.

### (Restoring to Fixed Positional Relation)

When there are a plurality of characters due to cloning, the fixed positional relation is such that the characters are arranged close to each other. However, the distance between the characters can increase due to the presence of a blocking area or an obstacle item. If characters remain far away from each other in this way, the characters disperse in the virtual space, degrading the controllability of the characters with one command from the player. To avoid this, a process for restoring characters that have become far away from each other to the fixed positional relation is performed in the game of the present example non-limiting embodiment.

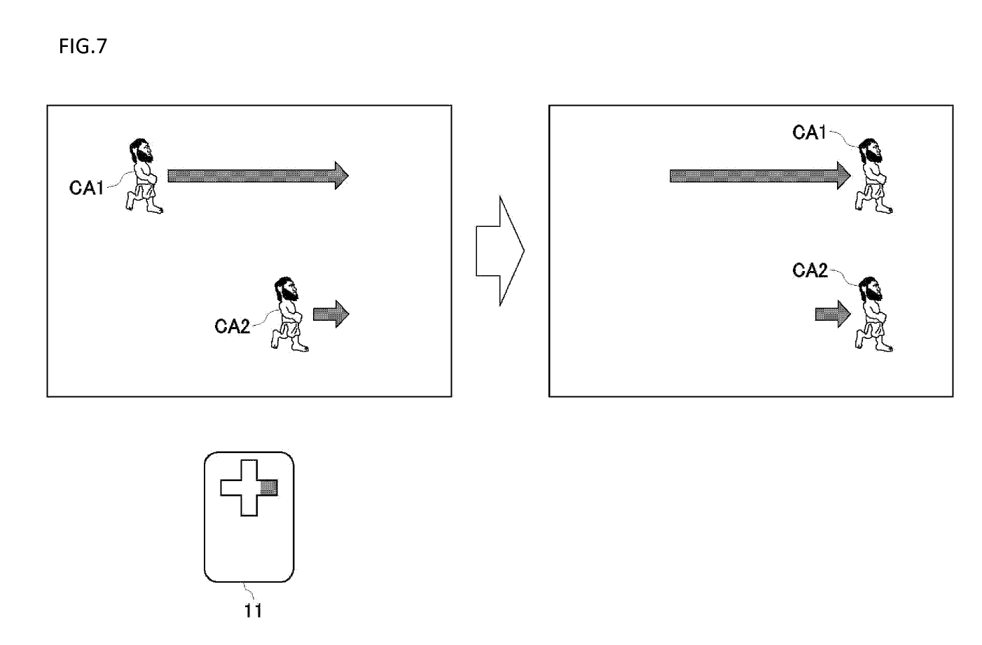

FIG. 7 shows an example non-limiting screen where a plurality of characters that have moved far away from each other are restored to the fixed positional relation and an operation on the controller. There are two characters CA1 and CA2 in the example in FIG. 7. The characters CA1 and CA2 are away from each other both horizontally and vertically. When the player issues a command to move rightward, the character CA2 moves rightward at a predetermined rate of movement whereas the character CA1, which is away from the character CA2 in the left direction and is located behind the character CA2 in the movement direction, moves rightward faster than the character CA2 in order to reduce the distance to the character CA2 in the front in the direction of movement. In this process, the distance between the characters CA1 and CA2 in the vertical direction is not corrected, therefore the characters CA1 and CA2 remain away from each other.

That is, if a command to move is issued when there are a plurality of characters which are farther away from each other than when they are in the fixed positional relation, the character in the front in the direction of movement is moved at a usual rate whereas the character behind in the direction of movement is moved faster than usual so that the character at the rear comes close to the character in the front. This rate correction can bring characters that are far away from each other into the fixed positional relation while keeping the player feeling that he/she is controlling all of the plurality of characters.

Note that the relative positional relation in the directions other than the direction specified by a command in order to reduce the distance is not restored. That is, the all of the characters move only in the direction specified by the player. This can keep the player feeling that the player is controlling the plurality of characters with one command without feeling that that one of the character is the leader (moves according to the command) and the other(s) is a follower (moves in a way different from the way specified by the command). Alternatively, the distance between characters may be reduced not only in the direction specified by the player but also in another direction at the same time. In that case, the characters can more easily return to the fixed positional relation and the relative positional relation can be more quickly restored.

Note that if the player issues a command to move vertically in the example in FIG. 7, the character at the rear in the direction of movement moves closer to the character in the front and thus the vertical distance between the characters CA1 and CA2 is reduced. Note that if the player issues a command to move the character vertically when the characters CA1 and CA2 are horizontally in line with each other as shown in the example screen before movement in FIG. 6, the characters CA1 and CA2 move vertically and one of the characters catches up with the other, so that the characters are arranged side by side (see FIG. 5). Here, the character in the front in the direction of movement and the character that was behind that character and has caught up with that character may squeeze together to position themselves side by side. Furthermore, in a situation where characters cannot position themselves side by side, the character at the rear in the direction of movement may merely catch up with the character in the front and the characters may keep moving in tandem.

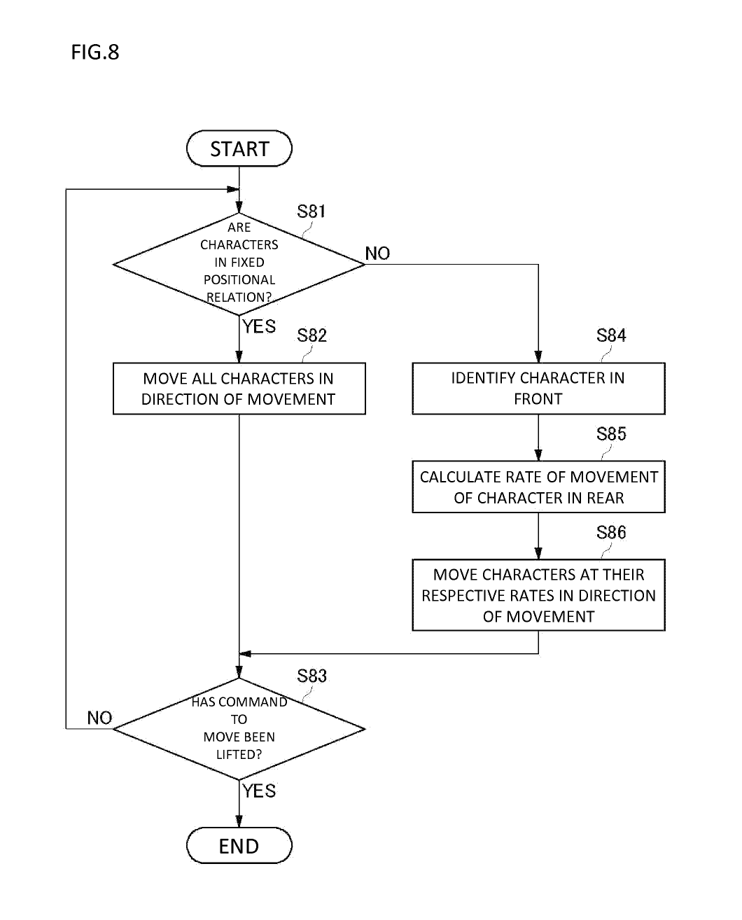

FIG. 8 shows a flowchart of an example non-limiting process for restoring a fixed positional relation between a plurality of characters. When the player issues a command to move, the flow in FIG. 8 is initiated. The information processing unit 14 first determines whether or not all of the characters are in the fixed positional relation (step S81). If all of the characters are in the fixed positional relation (YES at step S81), all of the characters are moved in the direction of movement in a formation according to the direction of movement (step S82). Then the information processing unit 14 determines whether or not the command to move has been lifted (step S83). If the command to move has not been lifted (NO at step S83), the information processing unit 14 returns to step S81, where the information processing unit 14 determines whether or not all of the characters are in the fixed positional relation.

When any of the characters is not in the fixed positional relation with the other characters (NO at step S81), the information processing unit 14 first identifies the character in the front in the direction of movement specified by the player (step S84). There may be more than one character in the front. The information processing unit 14 then calculates the rate of movement of the character in the rear that depends on the distance to the character in the front (step S85), causes the character in the front to move at a usual rate, and causes the character in the rear to move at the calculated rate in the virtual space (step S86). Here, the greater the distance to the character in the front, the higher the calculated rate of movement of the character in the rear is. If a plurality of characters in the fixed positional relation are in the front, those plurality of characters move in a formation according to the direction of movement. When the command to move has not been lifted (NO at step S83), the information processing unit 14 returns to step S81, where the information processing unit 14 determines whether or not all of the characters are in the fixed positional relation, that is, whether or not the character at the rear has caught up with the character in the front as a result of the movements at the different rates.

While the rate of movement of the character in the rear is determined according to the distance to the character in the front, the rate of movement for allowing the character in the rear to catch up with the character in the front may be a rate that is fixed regardless of the distance between the characters. While the character in the front is moved at a usual rate and the character in the rear is moved at a rate faster than the usual rate to reduce the distance between the characters, the character in the rear may be moved at the usual rate whereas the character in the front may be moved at a rate lower than the usual rate, or the character in the rear may be moved at a rate higher than the usual rate whereas the character in the front may be moved at a rate lower than the usual rate to reduce the distance between the characters.

### [Multiplayer Mode]

A multiplayer mode in which a plurality of players can play will be described below. In the multiplayer mode, a plurality of kinds of characters corresponding to a plurality of players appear in a virtual space and each of the players can control his/her own character(s). In the multiplayer mode, the same processes as those in the singleplayer mode in which a single player plays a game are performed. That is, processes such as production of clones of a character controlled by each player and restoration of a relative positional relation between the characters described above are performed. Processes added in the multiplayer mode will be described below.

### (Capturing Characters)

In the multiplayer mode, when there are a plurality of characters controlled by a plurality of players, a player can control his/her character(s) (hereinafter referred to as the “own character(s)”) to perform a certain action on a character controlled by an opponent player, thereby changing the character controlled by the opponent player to a clone character controlled by him/herself. That is, each player can capture one of characters controlled by any other player to change the character to a clone character controlled by him/herself.

In the present example non-limiting embodiment, the action for capturing a character controlled by an opponent player is a “Hip-Drop” or seated senton on the opponent. The “Hip-Drop” is performed by a player operating the down portion of the direction control key when his/her own character drops from above a target toward the target. This action is performed when the own character positioned above a target drops toward a target or when the own character jumps up above a target and then drops toward the target. In the present example non-limiting embodiment, when a player performs the “Hip-Drop” on one of characters controlled by an opponent player, the attacked character controlled by the opponent player is transformed to a character controlled by the attacking player.

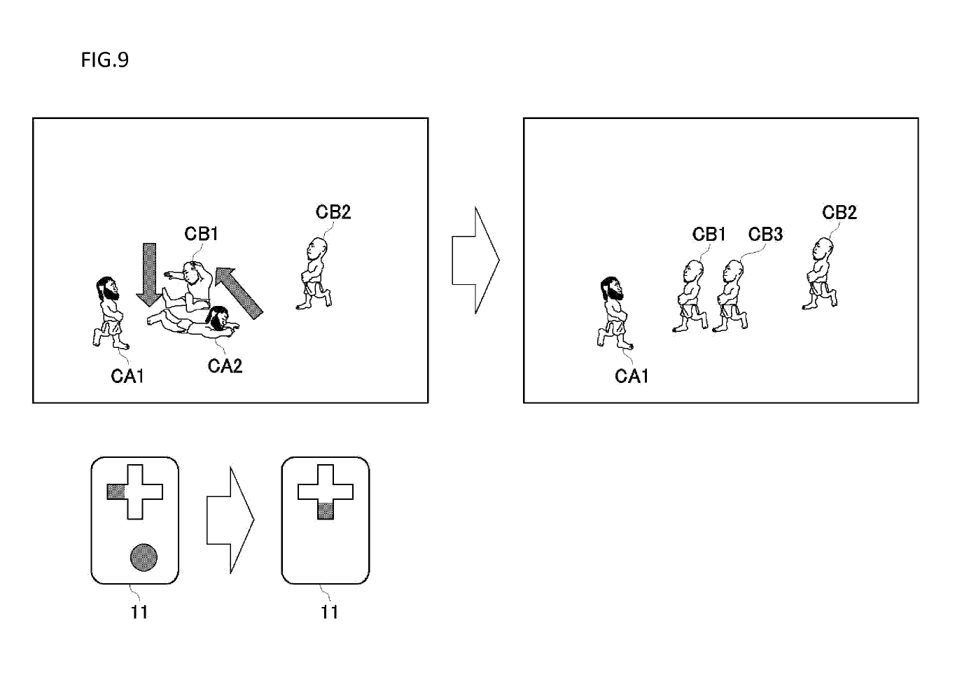

FIG. 9 shows an example non-limiting screen where a player captures a character controlled by an opponent player and an operation on the controller. In the example in FIG. 9, a first player has two characters CA1 and CA2 and a second player has two characters CB1 and CB2. The characters CA1 and CA2 controlled by the first player have the same appearance as each other and the characters CB1 and CB2 controlled by the second player have the same appearance as each other. However, the appearance of the characters CA1 and CA2 controlled by the first player and the appearance of the characters CB1 and CB2 controlled by the second player are different.

In the example in FIG. 9, the character CB1 is located to the right of the character CA2. In this situation, when the second player presses a jump button to command the character CB1 to jump while pointing to the left, the character CB1 jumps up above the head of the character CA2. When the second player points downward at the drop of the character CB1, the character CB1 executes a seated senton on the character CA2. If the seated senton is successfully executed, the character CA2 controlled by the first player is transformed to a character CB3 controlled by the second player. At the same time, the appearance of the character CA2 controlled by the first player is transformed to the appearance of the characters controlled by the second character.

### (Attacks to Characters Controlled by Opponent Player)

A player can control his/her own character to attack a character controlled by another player. When a character is attacked by a character controlled by an opponent player, the attacked character fell down on the spot and becomes temporarily unable to move. When one or more of a plurality of characters are attacked by a character controlled by an opponent player, only the attacked character(s) is prevented from moving whereas the other characters are able to move according to a command from the attacked player.

The singleplayer mode has been described earlier by taking an example where the distance between a plurality of characters increases as a character is prevented from moving by a blocking area or an obstacle. In the multiplayer mode, the movement of some of the characters is also restricted by an attack by a character controlled by an opponent player and, as a result, the distance between the plurality of characters increases.

### (Other Features)

As in the singleplayer mode described above, the maximum number of characters that can be produced is limited. In the multiplayer mode, an upper limit of the sum of the number of characters controlled by the first player and the number of characters controlled by the second player is preset.

When the distance between a character controlled by the first player and a character controlled by the second player becomes greater than or equal to a predetermined distance in the virtual space, the character of one of the players that is located farther from the goal in the virtual space goes out of the screen. When a character controlled by one of the players goes out of the screen and out of a survival area, the character controlled by that player is forced back to the location of the character controlled by the other player ahead of the player. At this point in time, a character(s) controlled by the player that has forced back disappears and only one character is left for the player.

While the present non-limiting example embodiment has been described in the context of a game whose objective is to move a character in a virtual space to allow the character to reach a goal, games to which the present technology can be applied is not limited to such a game. A game to which the present technology is applied may be a fighting game whose objective is to knock out an opponent character by controlling a character in a virtual space or may be a puzzle game whose objective is to work out a puzzle by controlling a character in a virtual space, or a game of any other type.

### REFERENCE SIGNS LIST

10: GAME APPARATUS
11: FIRST INPUT UNIT
12: SECOND INPUT UNIT
13: DISPLAY UNIT
14: INFORMATION PROCESSING UNIT

What is claimed is:

1. A non-transitory computer-readable storage medium having stored therein a game program causing a computer of a game apparatus that includes an input unit for receiving a command from a player and executes a game in which the player controls a plurality of characters in a virtual space to function as:
an information processing unit moving the plurality of characters according to the command and a relative positional relation between the plurality of characters in the virtual space.

2. The non-transitory computer-readable storage medium according to claim 1,
wherein the plurality of characters are individually subjected to a restriction on movement, so that a relative positional relation between the plurality of characters changes.

3. The non-transitory computer-readable storage medium according to claim 2,
wherein when the plurality of characters are not in a predetermined relative positional relation, the information processing unit moves the plurality of characters according to the command to bring the plurality of characters into the predetermined relative positional relation.

4. The non-transitory computer-readable storage medium according to claim 3,
wherein when the plurality of characters are not in a predetermined relative positional relation, the information processing unit moves the plurality of characters according to the command by making the rate of movement of at least one of the plurality of characters different from the rate of movement of the other characters to bring the plurality of characters into the predetermined relative positional relation.

5. The non-transitory computer-readable storage medium according to claim 3,
wherein when the plurality of characters are not in a predetermined relative positional relation, the information processing unit moves the plurality of characters according to the command to gradually bring the plurality of characters into the predetermined relative positional relation.

6. The non-transitory computer-readable storage medium according to claim 3,
wherein the predetermined relative positional relation is a positional relation in which the plurality of characters are arranged side by side.

7. The non-transitory computer-readable storage medium according to claim 6,
wherein the information processing unit changes a direction in which the characters are arranged according to the command.

8. The non-transitory computer-readable storage medium according to claim 7,
wherein the predetermined relative positional relation is a positional relation in which the plurality of characters are arranged in the direction perpendicular to a direction of movement specified by the command.

9. The non-transitory computer-readable storage medium according to claim 1,
wherein the information processing unit adds a character in the virtual space to produce the plurality of characters.

10. The non-transitory computer-readable storage medium according to claim 9,
wherein when any of the plurality of characters satisfies a predetermined condition for adding a character, the information processing unit produces a clone character from the character to add the character.

11. The non-transitory computer-readable storage medium according to claim 9,
wherein the information processing unit adds the character on conditions that the addition does not cause a predetermined upper limit of the number of the characters to be exceeded.

12. The non-transitory computer readable storage medium according to claim 1,
wherein the plurality of characters have the same appearance as each other.

13. The non-transitory computer-readable storage medium according to claim 1,
wherein all of the plurality of characters have the same abilities.

14. A game apparatus executing a game in which a plurality of characters in a virtual space are controlled, the game apparatus comprising:
an input unit for receiving a command from a player; and
an information processing unit moving the plurality of characters according to the command and a relative positional relation between the plurality of characters in the virtual space.

15. A game system executing a game in which a plurality of characters in a virtual space are controlled, the game system comprising:
an input unit for receiving a command from a player; and
an information processing unit moving the plurality of characters according to the command and a relative positional relation between the plurality of characters in the virtual space.

16. A game processing method of executing a game in which a plurality of characters are controlled in a virtual space, the game processing method comprising:
a command receiving step of receiving a command from a player; and
an information processing step of moving the plurality of characters according to the command and a relative positional relation between the plurality of players in the virtual space.
